(19) United States
(12) Patent Application Publication
(10) Pub. No.: US 2015/0186823 A1
(43) Pub. Date: Jul. 2, 2015

(54) METHODS, SYSTEMS AND COMPUTER-READABLE MEDIA FOR COMPONENTIZING A BUSINESS REQUIREMENT

(71) Applicant: Infosys Limited, Bangalore (IN)

(72) Inventors: Venkatesh Santemavathur Gopalkrishna, Bangalore (IN); Prasad Chandrashekaraiah, Bangalore (IN); Jasdeep Singh Kaler, Bangalore (IN); Mukundad, Bangalore (IN); Anshul Jain, Bangalore (IN); Praburam Selvaraj, Bangalore (IN)

(73) Assignee: Infosys Limited, Bangalore (IN)

(21) Appl. No.: 14/562,404

(22) Filed: Dec. 5, 2014

(30) Foreign Application Priority Data
Dec. 26, 2013 (IN) 6085/CHE/2013

(51) Int. Cl. G06Q 10/06

(52) U.S. Cl. CPC G06Q 10/06313

(57) ABSTRACT

The present invention provides a method and system for componentizing a business requirement. The business requirement can be qualified for the componentizing based on a predefined set of criteria. The one or more business object can be identified for the qualified requirement based on a set of rules. The one or more business object can be designed and certified for application usage.

### FIELD

The field relates generally to business process management systems. More specifically, the field relates to a method and system for componentizing a business requirement.

### BACKGROUND

Existing business process management systems cater to various business gaps and requirements on a need basis. Whenever a business gap viz. a business requirement is identified, one or more business components also referred to herein as business objects shall be designed for catering to a set of functionalities required by the business gap. Over a period of time, as more business gaps are identified a collection of the one or more business components tends to increase thereby becoming unmanageable and redundant, as there could be a likelihood, that two or more business components developed may cater to similar set of functionalities.

Hence there is a need for a system that can develop a single reusable set of business components, to cater to the business requirement, rather than redeveloping the one or more business components for every business requirement. The alternate system and method must express the business requirement into the one or more business components that may be orchestrated and modified in future. Thus an optimized system and method for componentizing the business requirement is proposed.

### SUMMARY

The present invention provides a method and system for componentizing a business requirement. In accordance with a disclosed embodiment, the method may include qualifying the business requirement for the componentizing, based on a predefined set of criteria. Further, the method shall include, identifying one or more business object for the qualified business requirement, based on a set of rules. The one or more business object can be designed and certified based on a set of guidelines.

In an additional embodiment, a system, for componentizing a business requirement has been proposed. In accordance with a disclosed embodiment, the system may include a qualification engine, configured to filter a business requirement for componentizing. Further, the system may include an identification module, configured to identify one or more business objects for the filtered business requirement, based on a set of rules. A design module, shall be configured to develop the one or more business object, and a certification module, can be configured to certify the one or more business object.

These and other features, aspects, and advantages of the present invention will be better understood with reference to the following description and claims.

### BRIEF DESCRIPTION OF THE DRAWINGS

FIG. 1 is a flowchart illustrating an embodiment of a method for componentizing a business requirement.

FIG. 2 is a flowchart illustrating a preferred embodiment of a method componentizing a business requirement.

FIG. 3 is a system illustrating a framework for componentizing a business requirement.

FIG. 4 illustrates a generalized example of a computing environment 300.

While systems and methods are described herein by way of example and embodiments, those skilled in the art recognize that systems and methods for managing a local stack are described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for componentizing a business requirement. More specifically the methods and systems disclosed specify embodiments for developing reusable business objects essential for executing functionality of the business requirement.

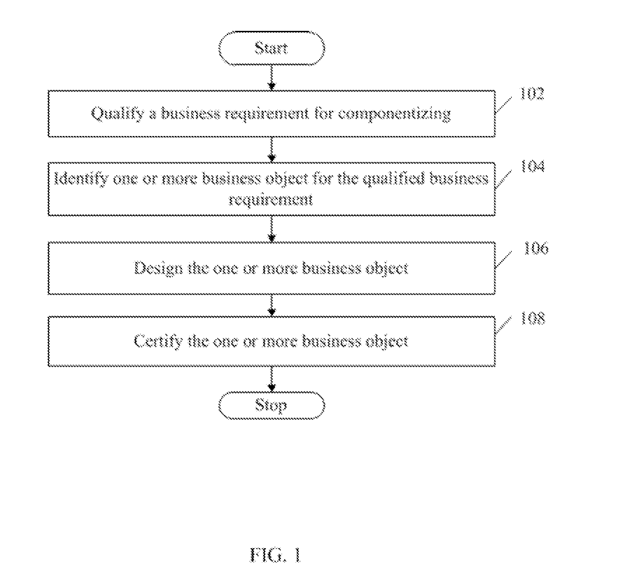

FIG. 1 is a flowchart that illustrates a method performed for componentizing a business requirement in accordance with an embodiment of the present invention. At step 102, a business requirement alternatively known as a business gap, shall be identified and qualified for componentization based on a predefined set of criteria. The business requirement shall be evaluated for a potential opportunity of reuse and whether the business requirement is available for more than one solution. In other words in an event the business requirement is specific to a single solution, such business requirement shall not qualify for the componentization. Further, the business requirement shall be evaluated for a standard integration with an industry standard third party tool. A customization work size for the business requirement maybe evaluated before qualifying the business requirement for componentization. The business requirement maybe evaluated against a need for a similar requirement in a region and across regions.

At step 104, one or more business object shall be identified for the qualified business requirement, based on a set of rules. The business gap can be decomposed into a set of isolated independent units, where each such unit can be componentized. At step 106, the one or more business object can be designed based on validation and business logic, table designs and such existing criteria. At step 108, the designed one or more business object can be certified, for future usage.

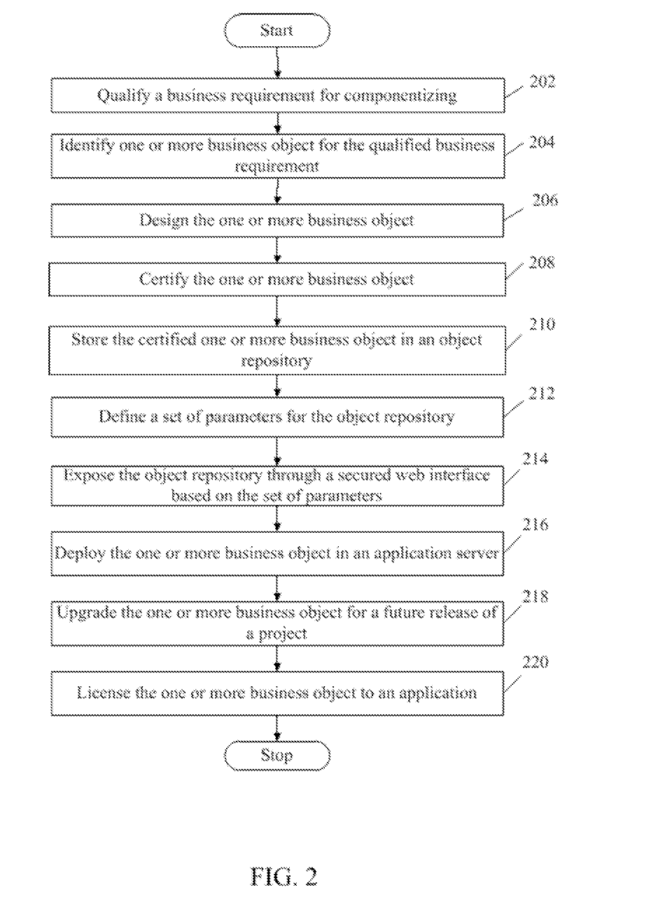

FIG. 2 is a flowchart that illustrates an alternative method performed for componentizing a business requirement. At step 202, a business requirement can be qualified for componentizing based on a predefined set of rules. The predefined set of rules could include for instance componentizing the business requirement only when a need exists for a similar business requirement across regions. The business requirement maybe componentized only if there exists a potential opportunity for reuse and the business requirement caters to a general solution. The qualified business requirement must possess high re-usability across implementations. Componentization must have minimal impact on existing designs of another business requirement. Further the componentization must not impact any implementation activity timelines. At step 204, one or more business object can be identified for the qualified business requirement. At step 206, the one or more business object shall be designed. The designing shall ensure that common routines and functions shall be written for validation and business logic. Data functions shall be defined in a generic manner so that in future provision for adding more arguments or data members to the data functions can be made. Each business object can have an identifier id, which can be unique across all business implementations. Further, the one or more business objects can be made available with object comments for easy code walk through. Specific review measures can be taken while designing of the one or more business object. Further, at step 208, the one or more business object can be certified by following a set of procedures. For instance, functional requirements of the one or more business objects can be tested, and a correctness of a structural or an interaction requirement with another business object can be tested. Further, defects can be injected through a data for testing the one or more business object. Regression test results can be tested when an object repository is updated with additional features and functionalities. In another instance, black-box testing can be done on the one or more business object. One performing aforementioned procedures, the one or more business object can be certified. At step 210, the one or more certified business object can be stored in an object repository. Further, at step 212, a set of parameters can be defined for the object repository, that determines a manner of reusability of the one or more business object. The set of parameters can usually guide a manner of storing the one or more business objects in the object repository. Input to the object repository can be a componentized code of the one or more business object. A check may need to be done for verifying whether the one or more business object is certified and a defect related to the one or more object is fixed. Packaging of a technical unit of the one or more business object can be checked for easy usage and deployment. A release note of the one or more business object can be checked with required details. The release note can contain features and deployment aspect of the one or more business object, with all dependencies and configurations required for a working of the one or more business object. A patent or intellectual property issue of the one or more business object can be checked for clearance. Licensing of the one or more business object can be checked in order to determine if the one or more business object is a free object.

At step 214, the object repository can be exposed through a secured web interface based on the defined set of parameters. The one or more business object can be deployed on an application server at step 216, for usage by one or more applications. The one or more business object can be upgraded for a future release of the project at step 218. At step 220, the one or more business object can be licensed to an application. The alternative embodiment can be deployed in a financial core banking product, where the one or more business objects shall componentize a financial requirement of a banking business.

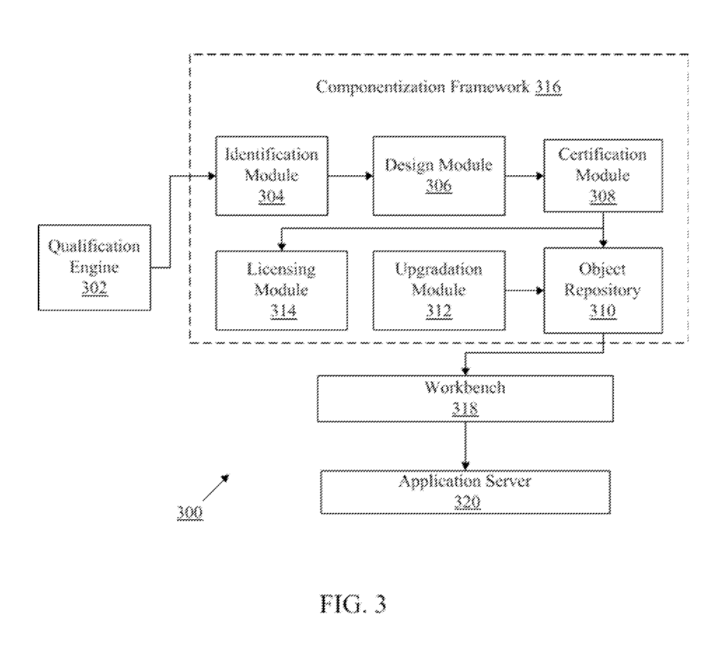

FIG. 3 illustrates a system in which various embodiments of the invention can be practiced. The system 300, includes a componentization framework 316, that may include a set of componentization modules essential for building one or more business objects. The componentization framework 316 can include an identification module 304, a design module 306, a certification module 308, a licensing module 314, an upgradation module 312, an object repository 310, a workbench 318, and an application server 320. The componentization framework 316, can interact with a qualification engine 302, in order to receive a gap or a business requirement for componentization. The qualification engine 302, can be designed to filter the gap based on a predefined set of criteria. The identification module 304, can be configured to identify the one or more business object for the filtered gap viz. the filtered business requirement based on a set of rules. The design module 306, can be configured to develop the one or more business object and the certification module 308, shall be configured to certify the one or more business object. The design module 306, shall maintain a compatibility of the one or more business object with a future release of the project. The certification module 308 shall refer to a set of guidelines for certifying the one or more business object. On being certified the one or more business object can be stored in the object repository 310 for future use. The workbench 318, shall expose the object repository 310, viz. the one or more business object through a secured web interface. The upgradation module 312, can be configured to upgrade the object repository 310 for a future release of a project. The licensing module 314, can be configured to license the one or more business object to an application.

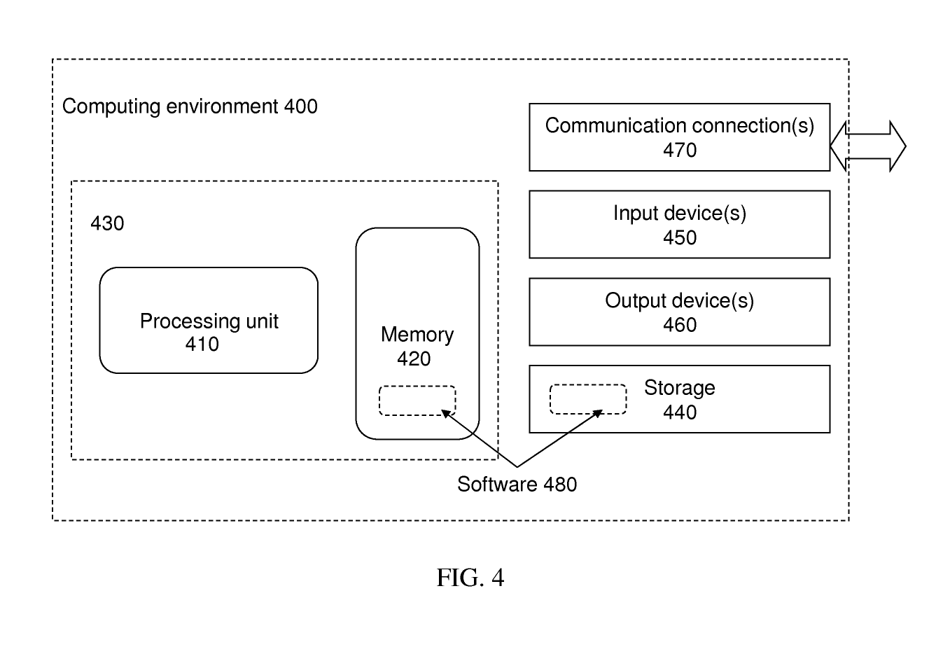

One or more of the above-described techniques can be implemented in or involve one or more computer systems. FIG. 4 illustrates a generalized example of a computing environment 300. The computing environment 300 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 310 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

We claim:

1. A method for componentizing a business requirement, the method comprising:
qualifying the business requirement for the componentizing, based on a predefined set of criteria;
identifying one or more business object for the qualified business requirement, based on a set of rules;
designing the one or more business object; and
certifying the one or more business object.

2. The method of claim 1, further comprising:
storing the certified one or more business object in an object repository;
defining a set of parameters for the object repository;
exposing the object repository through a secured web interface based on the set of parameters; and
deploying the one or more business object in an application server.

3. The method of claim 1, further comprising;
upgrading the one or more business object for a future release of a project; and
licensing the one or more business object to an application.

4. The method of claim 3, wherein the step of designing the one or more business objects, maintains compatibility with the future release of the project.

5. The method of claim 1, wherein the one or more business object is certified based on a set of guidelines.

6. A system for componentizing a business component, the system comprising:
a qualification engine, configured to filter a business requirement for the componentizing, based on a predefined set of criteria;
an identification module, configured to identify one or more business object for the filtered business requirement, based on a set of rules;
a design module, configured to develop the one or more business object; and
a certification module, configured to certify the one or more business object.

7. The system of claim 6, further comprising:
an object repository, configured to store the certified one or more business object;
a workbench, configured to expose the object repository based on a set of parameters; and
an application server, configured to host the certified one or more business object.

8. The system of claim 6, further comprising:
an upgradation module configured to upgrade the one or more business object for a future release of a project; and
a licensing module, configured to license one or more business object to an application.

9. The system of claim 8, wherein the design module is further configured to maintain compatibility of the developed one or more business object with a future release of the project.

10. The system of claim 6, wherein the certification module, is further configured to refer to a set of guidelines, for certifying the one or more business object.

11. A computer program product comprising a plurality of program instructions stored on a non-transitory computer-readable medium that, when executed by a computing device, performs a method for componentizing a business requirement, the method comprising:
qualifying the business requirement for the componentizing, based on a predefined set of criteria;
identifying one or more business object for the qualified business requirement, based on a set of rules;
designing the one or more business object; and
certifying the one or more business object.
